(19) United States
(12) Patent Application Publication
(10) Pub. No.: US 2003/0215547 A1
(43) Pub. Date: Nov. 20, 2003

(54) Pet treat coating composition and process

(76) Inventor: Joseph Conrad Leyh JR., Mt. Pleasant, SC (US)

Correspondence Address: KATHLEEN M HARLESTON, THE HARLESTON LAW FIRM, 909 TALL PINE ROAD, MT PLEASANT, SC, 29464

(21) Appl. No.: 10/437,700

(22) Filed: May 14, 2003

Related U.S. Application Data
(60) Provisional application No. 60/381,164, filed on May 16, 2002.

(51) Int. Cl. A23L 1/00

(52) U.S. Cl. 426/98

(57) ABSTRACT

A composition for coating a pet treat or a particulate pet food includes: (a) from about 25 to about 100 weight % of edible hydrogenated animal fat and/or hydrogenated vegetable oil having a melting point between about 100 and about 160 degrees Fahrenheit. The coating composition preferably further includes: (b) from about 2 to about 75 weight % of an edible, natural and/or artificial flavorant; (c) from about 20 to about 75 weight % of an edible, inert filler component, such as maltodextrin, wheat or rice flour, corn syrup or sugar; (d) from about 0.05 to about 15 weight % of a nutritional additive, such as vitamins, minerals, plant extracts, digestive aids, or odor control ingredients; and (e) from about 0.01 to about 5% weight of an edible, artificial and/or natural colorant. Also included is a process for making a coated pet treat coating that does not involve baking on the coating.

### CROSS REFERENCE TO RELATED APPLICATIONS

Benefit is claimed under 35 USC 119(e) of provisional U.S. patent application No. 60/381,164 filed on May 16, 2002.

### BACKGROUND OF THE INVENTION

1. Technical Field

The present invention relates to a coating composition for a pet treat or dry pet food that minimizes staining of the surrounding area, and a bake-free method for coating pet food and pet treats with the coating composition, which may be colored, flavored and/or nutritionally fortified.

2. Background Information

The pet food and treat industry has grown significantly in the last decade. Baked pet treats, rawhide treats, and rawhide chew bones have contributed to this growth, offering a variety of flavors and colors to enhance consumer appeal and pet acceptance. The high level of artificial coloring attracts the attention of pet owners, but does not provide any additional flavor for the pet. Unfortunately, adding flavors and surface coating products with high levels of artificial coloring have created a significant “stain” problem, which detracts from the overall growth potential for enhanced rawhide products. Many dog owners, for example, will not purchase “colored” or “flavored” dog treats because coloring and/or flavoring additives stain carpets, furniture, and/or pet fur when the dog consumes the treat. As the treat is broken down by the dog's chewing motions and saliva, the colored coating discolors the pet owner's carpeting or fabric. The coloring can also discolor the coats of light colored pets, particularly the mouth area of white-coated dogs. The industry has seen an increasing number of customer complaints of carpet, furniture and hair coat stains. This is a valid, recognized problem.

Also, many of the coated treats available in today's market are subjected to extensive, high temperature drying processes, resulting in color degradation and aroma and flavor loss. This reduces both consumer appeal and animal acceptance.

The present invention eliminates, or at least greatly minimizes, the potential for staining, flavor loss, and color degradation associated with artificially colored and/or flavored treats in the market today. When applied to the surface of dry pet treats or dry pet food products, this stain-free coating will enhance color, aroma, and flavor characteristics of the finished product.

Advantages of the coating composition and process of the present invention include the following:

1. the coating composition is substantial and attractive in appearance;

2. dry food and treats coated with the coating composition attract pets;

3. the resulting coated pet food and treats do not stain the area where they are stored or consumed by the pet;

4. the stain-free coating composition retains color, flavor, texture, and animal acceptance over time, regardless of processing, transportation, and storage conditions;

5. the ingredients of the composition are easily suspended in the coating and the composition is quick and easy to make;

6. some of the ingredients of the composition may be withheld from the formula and applied separately on the surface of the coating;

7. the coating is high in fat and offers nutritional energy for the pet;

8. the coating composition may be altered to include nutritional additives for health benefits;

9. the coating is inexpensive and easy to apply to the treat or dry food; and

10. the coating process herein does not require costly baking or drying processes.

### BRIEF SUMMARY OF THE INVENTION

The present invention is a composition for coating a pet treat or a particulate pet food, which preferably includes:

a) from about 25 to about 100 weight % of hydrogenated animal fat or hydrogenated vegetable oil, the fat or oil having a melting point between about 100 and about 160 degrees Fahrenheit; and preferably:

b) from about 0.5 to about 75 weight % of a natural and/or artificial flavorant;

c) from about 20 to about 75 weight % of an edible, inert filler component;

d) from about 0.05 to about 15 weight % of a nutritional additive; and/or

e) from about 0.01 to about 5% weight of an edible, artificial and/or natural colorant.

The present invention also includes a process for making a coated pet treat or coated particulate pet food, comprising the steps of:

a) subjecting the pet treat or particulate pet food to a liquefied coating composition comprising at least about 25 weight % of hydrogenated animal fat or hydrogenated vegetable oil having a melting point between about 100 and about 160 degrees Fahrenheit, thereby forming a surface coating of such liquefied coating composition on the pet food or pet treat; and

b) subjecting the coated pet food or coated pet treat to ambient air, allowing the coating composition to cool to room temperature;

wherein the process does not comprise baking in an oven or drying in a drier, which are required by most conventional, water-based pet treat or dry pet food coatings.

### DESCRIPTION OF THE INVENTION

The present invention is a composition for coating a dry pet treat, such as a dog biscuit or rawhide chew treat, or a particulate dry pet food. A coating composition of the present invention includes:

a) from about 25 to about 100 weight % of hydrogenated animal fat and/or hydrogenated vegetable oil, having a melting point between about 100 and about 160 degrees Fahrenheit; and preferably with less than about 10 weight % of hydrogenated or non-hydrogenated animal fat or vegetable oil having a melting point below about 100 degrees Fahrenheit. A more preferred composition is substantially free of hydrogenated or non-hydrogenated animal fat or vegetable oil having a melting point below about 100 degrees Fahrenheit, or above about 160 degrees Fahrenheit. The coating composition of the present invention preferably further includes:

b) from about 2 to about 75 weight % of a natural and/or artificial flavorant, such as a peanut butter, cheese, meat, poultry, fish, and/or vegetable additive;

c) from about 20 to about 75 weight % of an edible, inert filler component, such as maltodextrin, wheat or rice flour, corn syrup or sugar;

d) from about 0.05 to about 15 weight % of a nutritional additive, such as vitamins, minerals, plant extracts, digestive aids, or odor control ingredients; and/or

e) from about 0.01 to about 5% weight of an edible, artificial and/or natural colorant.

By “stain-free” herein is meant minimizing, and preferably eliminating, staining of pet fur, or the area where the coated food or treats are stored or consumed by the pet.

The “pets” referred to herein are mainly dogs and cats, which are the most frequently kept pets in the United States. The pet food herein is preferably dry, particulate dog food, such as kibble. Pet treats herein are preferably baked biscuit or rawhide bone or rawhide composite. The coating composition of the present invention can be applied to the pet food or pet treat by any suitable means, such as dipping, coating, basting, or spraying. The coating composition is applied at a temperature between about 90 and about 200 degrees Fahrenheit, more preferably between about 110 and about 140 degrees Fahrenheit, most preferably about 125 degrees Fahrenheit. At the higher temperature range of 160 to 200 degrees Fahrenheit, which is normally above the melting point of the hydrogenated fat/oil, the compositions have a low viscosity. The resulting coatings are therefore thin and more economical, which is desirable in some applications. The coating composition, which is high in total solids and low in moisture content, has a low microbiological profile.

Hydrogenated fats and oils have been used in food products since about 1911. Hydrogenation is a chemical reaction involving the addition of hydrogen across a double or triple bond in an organic compound. This reaction, which is a “reduction” process, must be completed in the presence of a catalyst and is often called a “catalytic hydrogenation.” Generally, margarines and shortenings are the results of only “partially hydrogenated” oils. As the level or degree of hydrogenation increases, fat texture is firmer and the melting point of the fat or oil also increases.

The first and primary component of the present invention is hydrogenated animal fat and/or hydrogenated vegetable oil with a melting point between about 100 and 160 degrees Fahrenheit, more preferably between about 125 and about 150 degrees Fahrenheit. Hydrogenated animal fats or oil from vegetable sources are suitable for use herein, so long as they have this high melting point. The amount of hydrogenated or non-hydrogenated fat/oil, or fat/oil with a melting point below about 100 degrees Fahrenheit, should be kept at a minimum, or below about 10 weight %. The coating composition is most preferably substantially free of hydrogenated or non-hydrogenated animal fat or vegetable oil with a melting point below about 100 degrees Fahrenheit, or above about 160 degrees Fahrenheit.

Hydrogenated animal fat suitable for use herein can be derived from bovine, porcine, poultry, or lamb fat sources. Hydrogenated vegetable oil suitable for use herein can be derived from soybean, corn, sunflower, safflower, canola, cottonseed, palm, or coconut sources. Trace amounts of impurities and other ingredients can be, and often are, found in hydrogenated fats and oils. Non-hydrogenated fats and oils are preferably not used herein, except in small amounts. Also, hydrogenated animal fats may be combined with hydrogenated vegetable oils for use herein. Most preferred for use herein are hydrogenated tallow or poultry fat, or hydrogenated soybean oil, corn oil, or cottonseed oil.

The present coating composition contains from about 25 to about 100 weight %, more preferably between about 25 and 98 weight %, most preferably between about 50 and about 69 weight %, of at least one hydrogenated animal fat or hydrogenated vegetable oil. Without meaning to be bound by theory it is believed that the present composition offers a high energy nutritional benefit, since this is a relatively high level of hydrogenated fat or oil. It is believed that such high nutritional benefits are not available from conventional pet food or treat coatings.

Also, compared to conventional coatings, hydrogenated fats and oils offer increased product stability. The composition of the present invention enrobes the pet food or pet treat in a shelf-stable, oxidation resistant, protective coating. It is believed that the coating is very unlikely to oxidize and become rancid. Surprisingly, it is believed that the present hydrogenated fat/oil-containing composition is unlikely to require the addition of anti-oxidant preservatives, even though such preservatives are normally a required ingredient in high fat pet foods.

A significant advantage of the present coating composition is that the hydrogenated fats/oils ingredient renders the colorant ingredient water-insoluble. During the blending phase of the present process, the colorant is dispersed in the mixture and is encapsulated in the hot, melted, hydrogenated fat and/or oil of the formula, creating a colorant/fat suspension. This high melting point, colored composition provides a stain-free coating for pet foods and pet treats. Pet foods and pet treats coated according to the present invention will not stain the pet's hair coat, or carpets, upholstery, bedspreads, etc. in the pet owner's home. Natural and artificial colorants formulated in the coating composition are bound by the high melting point hydrogenated fat/oil of the coating composition. Since room or ambient temperatures are very infrequently over 100 degrees Fahrenheit, the coating of the present invention does not melt at room temperature; therefore, it does not stain home furnishings or the fur of the pet consuming the coated food/treat.

Another advantage of the present invention is that the coating is cosmetically attractive. As the temperature of the melted coating composition cools, its viscosity increases. Conversely, as the composition temperature increases, its viscosity generally decreases. Herein, thick, viscous coatings are applied at temperatures approaching the melting point of the hydrogenated fat/oil ingredient of the present composition. Cheese-flavored compositions herein, which preferably incorporate cheddar cheese solids as a natural flavor additive, produce a thick, natural, golden cheese coating that looks and smells like cheddar cheese. Peanut butter is also preferably utilized herein as a natural flavor additive, producing a substantial, honey-brown peanut butter coating that looks and smells like peanut butter.

A further advantage of the present hydrogenated fat/oil-containing composition is stability during processing. Since coated pet foods/treats according to the present invention need not be baked in an oven or dried in a drier, flavor volatiles often lost during high temperature baking and drying processes are bound and preserved in the coating of the present invention. Therefore, pet foods and treats basted or otherwise coated with coatings of the present invention will maintain color stability, flavor and appearance during shipping and storage.

Hydrogenated fats and/or oils are relatively inexpensive. Since the majority of the ingredients in the preferred coating composition are inexpensive and the coating process herein is relatively simple, manufacturing coated pet foods and treats with the present invention is cost effective.

Hydrogenated fats and/or oils formulated in the present invention also allow for further enhancement of the treat by adhering flavored particles to the exterior of the treat or kibble for added appeal. Natural flavorants, such as bacon pieces, may be sprinkled onto the surface of the coating of the present invention while it is still hot for additional flavor and a pleasing appearance. Bacon pieces sprinkled onto the surface of a cheese coating composition provides a natural-looking “cheese and bacon” appearance. Peanut pieces sprinkled onto the surface of a peanut coating composition provide a “crunchy peanut butter” appearance. These attract pet owners, and provide a pleasing smell for the pet.

The second, preferred ingredient of the coating composition herein is a natural or artificial flavorant, or flavor-conveying ingredient. Preferred flavorants include: meat solids, or animal digest, such as beef, chicken or liver; vegetable flavors, such as tomato powder; herbs and spices, such as mint or parsley; vanilla extract; cheese or cheese solids; and peanut butter. The flavorant of the present invention appeals to both the pet owner and the pet. The aroma of the flavorant enhances the taste, acceptance and consumption of the pet food or treat. Overall animal acceptance is improved by the addition of the flavor component of the present invention. The coating composition may contain from about 2 to about 75 weight %, preferably between about 20 and about 50 weight %, of the flavorant.

The present coating composition also preferably includes from about 10 to about 75 weight %, preferably between about 20 and about 40 weight %, of an inert filler component. This ingredient fills out the coating and is a vehicle for the other ingredients of the composition. Preferred inert ingredients for use herein include maltodextrin, wheat flour, corn syrup, and/or natural or artificial sugars. Maltodextrin is partially hydrolyzed starch. Maltodextrin is classified according to DE, or dextrose equivalent, units. The maltodextrins have a DE less than about 20.

Nutritional additives, or supplements, are also preferred for use herein at a level of between about 0.05 and about 15 weight %, more preferably between about 2 and about 10 weight %. Suitable nutritional additives include vitamins, minerals, fatty acids, and/or nutriceuticals for providing one or more health benefits or treatments. There are nutritional additives suitable for inclusion herein that are said to promote hair growth, stop itchy, dry, flaky skin and hot spots, combat allergies, help to repel fleas, increase fertility, aid digestion, relieve gas, and improve appetite. Once these nutritional ingredients are mixed into the present composition during production, they remain relatively evenly suspended in the coating composition.

Other suitable nutritional additives for inclusion in the present composition include digestive aids. Certain known digestive enzymes for aiding digestion are desirable ingredients for inclusion in the present composition.

The word “nutriceuticals” was coined from the words “nutrition” and “pharmaceuticals”. They are non-prescribed, generally available substances that are taken orally and are believed to convey a physical benefit. Many types of nutriceuticals are available in health food stores, and many Americans are taking them on a daily basis and dosing their pets as well. Nutriceuticals suitable for use herein include chondroitin, shark cartilage, and glucosamine, which are said to alleviate symptoms of arthritis. Arthritis among dogs has become a surprisingly common medical problem known to pet owners and veterinarians alike. Glucosamine is a natural substance that stimulates the production of proteoglycans, which help maintain the health and resiliency of connective tissues. Glucosamine is also said to help restore damaged cells of cartilage tissue, and promote production of synovial fluid to lubricate the joints. Chondroitin is said to work together with glucosamine to improve damaged connective tissue and reduce joint inflammation. Chondroitin is a glycosaminoglycan.

Additionally, glutamine peptide is a nutriceutical suitable for use herein. Glutamine peptide is hydrolyzed wheat protein, and is said to help improve gastrointestinal, muscle, and immunity during stress. Glutamine is an amino acid.

Nutritional supplements for use herein also include plant extracts, such as herbs, kelp, flaxseed, chicory, whey proteins, and carotenoid-containing vegetables (collard greens, spinach, kale, etc.). Carotenoids suitable for use herein include lutein, which is believed to promote healthy eye functioning, and lycopene, which is said to prevent certain cancers. Chicory root or pulp is said to increase the level of beneficial bacteria in the animal's intestine. Chicory is a leafy plant with an upper, leafy portion, called endive, which is used in salads. Whey protein, which is a good source of amino acids, is said to combat detrimental bacteria and promote the growth of beneficial bacteria in the intestine. Whey protein is also said to aid immune functions, control certain cancers, and combat toxins.

Coated pet treats herein can be made expressly for facilitating the administration of oral medications or nutriceuticals to pets. It is often difficult to convince a dog or cat to swallow a pill. Also, some pets may refuse their food when powders or crushed pills have been distributed on their pet food. So long as the nutriceutical or medicine to be administered to the pet can withstand the relatively high temperatures in the present coating process, the pet can be given any ingestible pet treat with the medicated coating thereon, thus avoiding having to give the pet pills. The prescribed amount of nutriceutical can be incorporated into the coating during manufacture, and the pet owner would distribute the treats to the pet on a daily basis according to the prescribed dosage, and not be overly concerned about the treat coating not being fully ingested.

The nutriceutical, medication, or other desirable ingredient can alternatively be sprinkled on the exterior of the warm, coated pet treat, so that it sticks. For example, sodium bicarbonate powder and/or mint flavored particles or salts can be sprinkled on any suitable coating herein during manufacture to provide a teeth cleaning product claim. Since the sprinkling is on the exterior, it is more available to the pet's teeth or mouth as the treat is ingested. The teeth, which are the desired site of action, are contacted by the sodium bicarbonate powder as the dog chews the coating. The sodium bicarbonate on the pet's teeth has a cleaning action. The mint flavor improves the pet's breath for an abbreviated amount of time.

Lastly, the preferred composition herein further includes from about 0.01 to about 5 weight % of an artificial and/or natural colorant, such as caramel or carob coloring, FD&C colors, or FD&C Lakes. The color or color blend utilized is selected to correspond to the flavor of the coating composition. For example, a beef-flavored coating composition herein preferably has a dark brown coloring, and a cheese-flavored coating has golden yellow color. Colorants are included in the coating composition to improve product appearance and pet owner appeal.

A preferred composition herein comprises:

a) between about 50 and about 69 weight % of hydrogenated animal fat or hydrogenated vegetable oil, the hydrogenated fat or oil having a melting point between about 125 and about 150 degrees Fahrenheit;

b) between about 10 and about 50 weight % of an edible, natural or artificial flavorant;

c) between about 20 and about 40 weight % of an inert filler component;

d) between about 1 and about 10 weight % of a nutritional additive; and

e) between about 0.1 and about 3% weight of an edible, artificial or natural colorant.

Preferred compositions herein are preferably substantially free of hydrogenated or non-hydrogenated animal fat or vegetable oil having a melting point below about 100 degrees Fahrenheit, or above about 160 degrees Fahrenheit. A preferred composition herein has a ratio of between about 50:50 and about 70:30 hydrogenated fat or oil to flavorant, most preferably about 60:40 hydrogenated fat: flavorant. Most preferred is 60:40 hydrogenated tallow to cheese flavorant.

The ingredients of the present invention bind well, and the formulas are sufficiently thick for there to be no need for binding agents, starch, or polysaccharide gum in the formulas. Also, pH control substances and preservatives are not required because the present coating compositions are not water-based and do not promote microbial growth. The pH of the melted coating composition need not be monitored and controlled.

The present invention also encompasses a process for coating a dry pet food or pet treat with the coating composition herein. The process of the present invention includes the steps of:

a) subjecting the base pet treat or particulate pet food to a liquefied coating composition comprising at least about 25 weight % of hydrogenated animal fat and/or hydrogenated vegetable oil having a melting point between about 100 and about 160 degrees Fahrenheit, thereby forming a surface coating of such liquefied coating composition on the pet food or pet treat; and

b) subjecting the coated pet food or coated pet treat to ambient air, allowing the coating composition to cool to room temperature;

wherein the process does not comprise baking in an oven or drying in a drier.

Preferably, the process steps herein include:

1) blending and homogenizing the at least 25 weight % of hydrogenated fat and/or oil having a melting point between 100 and about 160 degrees Fahrenheit, preferably between about 125 and about 150 degrees Fahrenheit, and at least 0.5 weight % of a flavor ingredient.

2) coating the pet food or pet treat by any suitable means, such as, glazing, dipping, basting, or spraying at a temperature between about 90 and about 200 degrees Fahrenheit, preferably at about 110 and about 140 degrees Fahrenheit, and most preferably at about 125 degrees Fahrenheit.

3) cooling the coating composition and pet food or treat to a temperature of at least 100 degrees Fahrenheit, preferably less than between about 30 and about 90 degrees Fahrenheit, most preferably between about 50 and about 75 degrees Fahrenheit.

The process of the present invention preferably further comprises the step of adhering flavorant or abrasive, tooth cleaning particles to the exterior of the dry pet treat or food particle, most preferably by sprinkling the surface of the coated treat or food with the flavorant particles while the coating is still warm. The adhered flavorant particles are preferably peanut butter chips or bacon bits.

The total finished product, including the present coating and the base pet food or pet treat, contains moisture in the range of about 5 to about 10 weight %, which is an acceptable moisture range for microbiological stability. The process does not comprise baking or drying excess moisture to achieve microbiological stability.

Ingredients are easily dispersed in the formulated composition utilizing a high shear mix system designed to minimize air vortex and foaming during mixing. The composition is gradually heated to the preferred temperature. Once it is mixed, the homogeneous coating composition is transferred to a jacketed holding tank for application to the pet food or pet treat. The coating composition can be applied to the pet food or pet treat by dipping, basting, glazing or spraying. Other suitable coating application methods may alternatively be employed.

As the coating cools, the composition adheres to the surface of the pet food or pet treat much like a thick, creamy gravy, providing a pleasing appearance. The contrasting soft texture and substantial appearance of the present invention, when compared to existing “flavored” and “coated” pet foods and treats, is a significant improvement.

The following examples are intended to further illustrate the invention and facilitate its understanding. These examples are given solely for the purposes of illustration and are not to be construed as limiting in any way the present invention.

### EXAMPLE I

The following illustrates a coating composition of the present invention, a process for preparing the composition, and a process for applying the coating to a rawhide bone treat according to the present invention. The coating composition set forth in the following table is prepared.

TABLE I

| Ingredient | Type of Ingredient | Weight % |
|---|---|---|
| Hydrogenated Tallow | Hydrogenated Fat | 100.0 |

To prepare the coating composition, the hydrogenated tallow is heated to a temperature between about 125 and 140 degrees F., until the tallow is melted. A curtain coating process is utilized to coat the hot, liquefied coating composition over the rawhide bone. The hot coating composition is pourable and coats the surface of the rawhide bone. No post-application baking or special drier is required.

RESULTS: The rawhide bone has a stain-free coating of hydrogenated tallow that remains on the surface of the bone. The coating is thick, substantial in appearance, and stable over time.

### EXAMPLE II

The following illustrates a coating composition of the present invention, a process for preparing the composition, and a process for applying the coating to a hard, dry, baked biscuit treat according to the present invention. The coating composition set forth in the following table is prepared.

TABLE II

| Ingredient | Type of Ingredient | Weight % |
|---|---|---|
| Hydrogenated Tallow | Hydrogenated Fat | 70.0 |
| Peanut Butter | Flavor | 25.0 |
| Peanut Chips | Flavor | 5.0 |

To prepare the coating composition, the hydrogenated tallow is heated to a temperature between about 125 and 140 degrees F., until the tallow is melted. As the peanut butter is added to the mixing vessel, a high shear mixer is employed to disperse the peanut butter throughout the melted tallow.

The hot, liquefied coating composition is poured as a glaze over the surface of the dog biscuit. The hot coating composition is pourable and coats the surfaces of the biscuit. The coating is sufficiently thick, though, to remain on the surface of the dog biscuit and not be absorbed into the biscuit.

The dog biscuit is made in a conventional manner from a dough of ground wheat, meat/bone, and soybean meal, wheat flour, animal fat, and meat flavorant, which are mixed with water. After the dough is mixed in a suitable mixer, the dog biscuits are extruded and/or molded in a bone shape. The bone-shaped biscuits are then baked under appropriate conditions using suitable baking ovens, and dried in a drier.

Upon cooling, the biscuits are promptly coated and then sprinkled with peanut pieces and then transferred to a cooling conveyor with ambient air blown down onto the surface of the coated biscuits. No post-application baking or drying is required.

RESULTS: The biscuit has a stain-free coating of real peanut butter that remains on the surface of the biscuit treat. The coating is thick, substantial in appearance, and stable over time. The coating smells like peanut butter, and dogs appear to be excited by the smell and the taste of the coated biscuit.

### EXAMPLE III

The following illustrates a coating composition of the present invention, a process for preparing the composition, and a process for applying the coating to a commercially available rawhide retriever roll according to the present invention. A formulation of the present coating composition is set forth in the following table.

TABLE III

| Ingredient | Type of Ingredient | Weight % |
|---|---|---|
| Hydrogenated Soybean Oil | Hydrogenated Oil | 50.0 |
| Cheddar Cheese Powder | Flavor | 40.0 |
| Bacon Chips | Flavor | 10.0 |

To prepare the coating composition, the hydrogenated oil is heated to a temperature between about 125 and 140 degrees F. A high shear mixer is employed to disperse the cheese powder, which is slowly added to the mixing vessel, throughout the melted oil.

The rawhide retriever roll is dipped in the hot, liquefied coating composition. The coating remains on the surface of the rawhide roll, where it fills the folds and centers of the roll. The coating is not absorbed into the rawhide. The coated rawhide roll is promptly sprinkled with the bacon pieces and then transferred to a cooling conveyor belt with cooled air blown down onto the surface of the coated rawhide roll. No post-application baking or drying is required.

RESULTS: The rawhide treat has a stain-free coating of real cheese and bacon that remains on the surface of the rawhide roll. The coating is thick, substantial in appearance, and smells like cheddar cheese.

### EXAMPLE IV

The following illustrates a coating composition of the present invention, a process for preparing the composition, and a process for applying the coating to commercially available dry kibbled dog food according to the present invention. A formulation of the present coating composition is set forth in the following table.

TABLE IV

| Ingredient | Type of Ingredient | Weight % |
|---|---|---|
| Hydrogenated Corn Oil | Hydrogenated Oil | 89.0 |
| Dried Beef Digest | Flavor | 10.0 |
| Liquid Smoke | Flavor | 0.5 |
| FD&C Brown Blend | Color | 0.5 |

To prepare the coating composition, the hydrogenated oil is heated to a temperature between about 125 and 140 degrees Fahrenheit. As the dried beef digest, liquid smoke, and brown color are added to the mixing vessel, a high shear mixer is employed to disperse the ingredients throughout the melted oil.

The dry kibbled dog food is sprayed with the hot, liquefied coating composition. The coating remains on the surface of the kibble, and is not absorbed into them. The coated kibble is transferred to a fluid bed cooling tunnel with refrigerated air circulating through the tunnel and onto the surface of the coated kibble. No post-application baking or drying is required.

RESULTS: The kibbled dog food has a stain-free coating of real beef that remains on the surface of the dry kibble. The coating is thick, substantial in appearance, and has a beef aroma and flavor.

### EXAMPLE V

The following illustrates a teeth cleaning, minty coating composition of the present invention, a process for preparing the composition, and a process for applying the coating to a commercially available tied rawhide bone treat according to the present invention. A formulation of the present coating composition is set forth in the following table.

TABLE V

| Ingredient | Type of Ingredient | Weight % |
|---|---|---|
| Hydrogenated Poultry Fat | Hydrogenated Fat | 71.0 |
| Maltodextrin | Inert | 15.0 |
| Sodium Bicarbonate | Nutriceutical | 10.0 |
| Mint Flavor | Flavor | 4.0 |

To prepare the coating composition, the hydrogenated fat is heated to a temperature between about 140 and 160 degrees F., until the fat is melted. As the maltodextrin, sodium bicarbonate, and mint flavor are added to the mixing vessel, a high shear mixer is employed to disperse the ingredients throughout the melted fat.

The rawhide bone is dipped and then glazed with the hot, liquefied coating composition. While the coating is still warm, approximately 30% of the sodium bicarbonate from the formula is sprinkled over the surface of the coating. The coating remains on the surface of the rawhide bone, providing a surface coating of mint flavor and baking soda for a fresh breath and teeth cleaning effect. The composition coating is not absorbed into the rawhide. The coated rawhide bone is transferred to a cooling tunnel with ambient air circulating through the tunnel and onto the surface of the coated rawhide. No post-application baking or drying is required.

RESULTS: The rawhide bone has a stain-free coating that includes the fresh mint and baking soda. The coating is thick, substantial in appearance, and has a mint aroma, which is also attractive to pet owner consumers.

### EXAMPLE VI

The following illustrates a chicken-flavored, nutritionally fortified coating composition of the present invention, a process for preparing the composition, and a process for applying the coating to a commercially available rawhide chip treat according to the present invention. A formulation of the present coating composition is set forth in the following table.

TABLE VI

| Ingredient | Type of Ingredient | Weight % |
|---|---|---|
| Hydrogenated Cottonseed Oil | Hydrogenated Oil | 59.0 |
| Dried Chicken Broth | Flavor | 25.0 |
| Glucosamine | Nutriceutical | 2.0 |
| Shark Cartilage | Nutriceutical | 2.0 |
| Fish Oil | Nutriceutical | 4.0 |
| Caramel Color | Color | 4.0 |

To prepare the coating composition, the hydrogenated oil is heated to a temperature between about 125 and 140 degrees F. As the chicken broth, glucosamine hydrochlorate, shark cartilage, fish oil, and caramel color are added to the mixing vessel in any order, a high shear mixer is employed to disperse the ingredients throughout the melted oil.

The rawhide chip is basted with the hot, liquefied coating composition. The coating remains on the surface of the rawhide chip, providing a surface coating of chicken flavor fortified with the joint therapy nutriceuticals. The composition coating is not absorbed into the rawhide. Once it is coated, the rawhide chip is transferred to a cooling tunnel with ambient air circulating through the tunnel and onto the surface of the coated rawhide chip. No post-application baking or drying is required.

RESULTS: The rawhide chip has a stain-free coating with a joint therapy claim associated with the nutriceutical ingredients. The chicken-flavored coating is thick, substantial in appearance, and smells like cooked chicken.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

It is to be understood that any amounts given herein are illustrative, and are not meant to be limiting. All ratios, parts, percentages, proportions, and other amounts stated herein are on a weight basis, unless otherwise stated herein, or otherwise obvious to one skilled in the art to which the invention pertains. All temperatures herein are in degrees Fahrenheit, unless otherwise stated herein.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A stain-free composition for coating a dry pet treat or particulate pet food, the coating composition comprising from about 25 to about 100 weight % of hydrogenated animal fat or hydrogenated vegetable oil, the hydrogenated fat or oil having a melting point between about 100 and about 160 degrees Fahrenheit.

2. A coating composition according to claim 1, comprising: from about 25 to about 90 weight % of the hydrogenated animal fat or hydrogenated vegetable oil; and less than about 10 weight % of hydrogenated or non-hydrogenated animal fat or vegetable oil having a melting point below about 100 degrees Fahrenheit.

3. A coating composition according to claim 2, further comprising: (a) from about 25 to about 98 weight % of the hydrogenated animal fat or hydrogenated vegetable oil; and (b) from about 2 to about 75 weight % of an edible, natural or artificial flavorant.

4. A coating composition according to claim 3, further comprising: (a) from about 25 to about 75 weight % of the hydrogenated animal fat or hydrogenated vegetable oil; and (c) from about 25 to about 75 weight % of an edible, inert filler component.

5. A coating composition according to claim 4, further comprising: (d) from about 0.05 to about 15 weight % of a nutritional additive.

6. A coating composition according to claim 4, further comprising: (e) from about 0.01 to about 5 weight % of an edible, artificial or natural colorant.

7. A coating composition according to claim 5, wherein the hydrogenated fat is tallow.

8. A coating composition according to claim 7, wherein the flavorant is peanut butter.

9. A coating composition according to claim 4, wherein the hydrogenated animal fat is lard or grease.

10. A coating composition according to claim 9, wherein the flavorant is meat solids or animal digest.

11. A coating composition according to claim 7, wherein the flavorant is a cheese product, and a ratio of hydrogenated fat or oil to flavorant is between about 50:50 and about 70:30.

12. A coating composition according to claim 8, wherein the inert filler component is maltodextrin.

13. A coating composition according to claim 5, wherein the nutritional additive is glucosamine, chondroitin, or shark cartilage.

14. A coating composition according to claim 7, wherein the nutritional additive is a vitamin or mineral.

15. A coating composition according to claim 8, wherein the nutritional additive is a plant extract.

16. A coating composition according to claim 11, wherein the nutritional additive is a digestive enzyme.

17. A coating composition according to claim 1 1, wherein the colorant is caramel or carob coloring.

18. A coating composition according to claim 9, which does not comprise an anti-oxidant preservative.

19. A coating composition according to claim 1, further comprising flavorant particles adhered to the exterior of the coated pet treat or coated pet food particle.

20. A coating composition according to claim 3, further comprising tooth-cleaning abrasive particles adhered to the exterior of the coated pet treat or pet food particle.

21. A coating composition according to claim 2, wherein no binding agents, starch, polysaccharide gum, pH control substances, or preservatives are present in the composition.

22. A composition for coating a dry pet treat or particulate pet food, the coating composition comprising:
a) between about 50 and about 69 weight % of hydrogenated animal fat or hydrogenated vegetable oil, the hydrogenated fat or oil having a melting point between about 125 and about 150 degrees Fahrenheit;
b) between about 10 and about 50 weight % of an edible, natural or artificial flavorant;
c) between about 20 and about 40 weight % of an inert filler component;
d) between about 1 and about 10 weight % of a nutritional additive; and
e) between about 0.1 and about 3% weight of an edible, artificial or natural colorant.

23. A coating composition according to claim 22, which is substantially free of hydrogenated or non-hydrogenated animal fat or vegetable oil having a melting point below about 100 degrees Fahrenheit, or above about 160 degrees Fahrenheit.

24. A process for making a coated pet treat or coated particulate pet food, the process comprising the steps of:
a) subjecting the pet treat or particulate pet food to a liquefied coating composition comprising at least about 25 weight % of hydrogenated animal fat or hydrogenated vegetable oil having a melting point between about 100 and about 160 degrees Fahrenheit, thereby forming a surface coating of such liquefied coating composition on the pet food or pet treat; and
b) subjecting the coated pet food or coated pet treat to ambient air, allowing the coating composition to cool to room temperature;
wherein the process does not comprise baking in an oven or drying in a drier.

25. A process according to claim 24, wherein the coating composition is applied at a temperature between about 90 and about 200 degrees Fahrenheit.

26. A process according to claim 24, further comprising the step of adhering flavorant particles to the exterior of the pet treat or food particle 27. A process according to claim 26, wherein the flavorant particles are adhered by sprinkling the surface of the coated treat or food with the flavorant particles while the coating is still warm.
